(19) United States
(12) Patent Application Publication
(10) Pub. No.: US 2007/0046635 A1
(43) Pub. Date: Mar. 1, 2007

(54) Electronic apparatus

(75) Inventors: Shigeki Nishiyama, Tokyo (JP); Kenji Shimano, Tokyo (JP); Satoshi Araki, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/512,041

(22) Filed: Aug. 28, 2006

(30) Foreign Application Priority Data
Aug. 31, 2005 (JP) P2005-251297

(51) Int. Cl. G09G 5/00

(52) U.S. Cl. 345/168

(57) ABSTRACT

According to one embodiment of the invention, An electronic apparatus comprises; a body including a keyboard exposed on an upper surface hereof; a display device including a display surface and movable to a first state, a second state and a third state; an inversion hinge for rotating the display device on an inversion axis to move the display device from the first state to the third state; a support unit connected to the display device by the inversion hinge; a rotation hinge for rotating the support unit on a rotation axis provided along a rear side of the body while connecting the body and the support unit to each other; and an operation device provided in the support unit coaxially with the inversion axis and for outputting a signal related to information displayed on the display device.

### CROSS-REFERENCE TO RELATED APPLICATIONS

This application is based upon and claims the benefit of priority from Japanese Patent Application NO. P2005-251297, filed Aug. 31, 2005, the entire contents of which are incorporated herein by reference.

### BACKGROUND

1. Field

The present invention relates to an electronic apparatus including a body, a display portion connected to the body by hinges, and a mechanism for inverting the display portion to turn a display screen of the display portion up/down with respect to the body.

2. Description of the Related Art

A Portable computer including a body having a keyboard provided in an upper surface of the body so as to be exposed, and a display portion having a built-in display device (Refer to JP-A-6-43967). The body and the display portion are connected to each other by hinges in a rear side when viewed from a user side has been proposed. The portable computer disclosed in JP-A-6-43967 further includes a mechanism for inverting a display screen of the display device with respect to the keyboard of the body.

An information processing apparatus further including another operation means than the keyboard as an input means for assisting the operation of the portable computer has been proposed (Refer to JP-A-2002-157078). In the information processing apparatus, the body or display portion has a jog dial composed of a rotary encoder portion, and a push switch portion.

In the portable computer disclosed in JP-A-2002-157078, it is impossible to execute an input operation through the keyboard when the display unit is laid on the body while the display surface is located so as to be exposed to the outside. Accordingly, such an input operation has to be executed through a touch panel provide on the display screen or through a keypad or joystick connected externally.

In the information processing apparatus disclosed in JP-A-2002-157078, the jog dial provided in the display portion is exposed on the outer circumferential edge side of the display portion. This jog dial is operated so as to be pushed from one direction toward the rotation axis of the jog dial. For this reason, the jog dial has to be operated while the display portion is held by fingers different from the finger operating the jog dial or held by a hand different from the hand operating the jog dial so that the display portion can be prevented from becoming wobbly. In the information processing apparatus having the jog dial provided in the body, the rotation raceway surface of the jog dial is not consistent with the angle of the display portion but is far from the display portion. For this reason, there is a discrepancy between an operating sense of the jog dial and a viewing sense of displayed information.

There has been still no available electronic apparatus including an operation portion provided for operating information displayed on a display portion both in the case where a display surface of the display portion rises up with respect to a body and in the case where the display device is inverted and laid on the body while the display surface is turned up.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a second state of an electronic apparatus according to a first embodiment of the invention;

FIG. 2 is an exemplary perspective view of a first state of the electronic apparatus depicted in FIG. 1;

FIG. 3 is an exemplary perspective view in the middle of inversion of a display device in the electronic apparatus depicted in FIG. 1;

FIG. 4 is an exemplary perspective view of a third state of the electronic apparatus depicted in FIG. 1; and

FIG. 5 is an exemplary sectional view of an operation device and a first inversion hinge in the electronic apparatus depicted in FIG. 1

FIG. 6 is an exemplary sectional view of a second inversion hinge in the electronic apparatus depicted in FIG. 1

FIG. 7 is an exemplary perspective view showing a second state of an electronic apparatus according to a second embodiment of the invention.

FIG. 8 is an exemplary perspective view of a first state of the electronic apparatus depicted in FIG. 7

FIG. 9 is a an exemplary perspective view in the middle of inversion of a display device in the electronic apparatus depicted in FIG. 7

FIG. 10 is an exemplary perspective view of a third state of the electronic apparatus depicted in FIG. 7.

### DETAILED DESCRIPTION

Various embodiments according to the invention will be described hereinafter with reference to the accompanying drawings. In general, according to one embodiment of the invention, an electronic apparatus comprises; a body including a keyboard exposed on an upper surface hereof, a display device including a display surface and movable to a first state, a second state and a third state; an inversion hinge for rotating the display device on an inversion axis to move the display device from the first state to the third state; a support unit connected to the display device by the inversion hinge; a rotation hinge for rotating the support unit on a rotation axis provided along a rear side of the body while connecting the body and the support unit to each other; and an operation device provided in the support unit coaxially with the inversion axis and for outputting a signal related to information displayed on the display device.

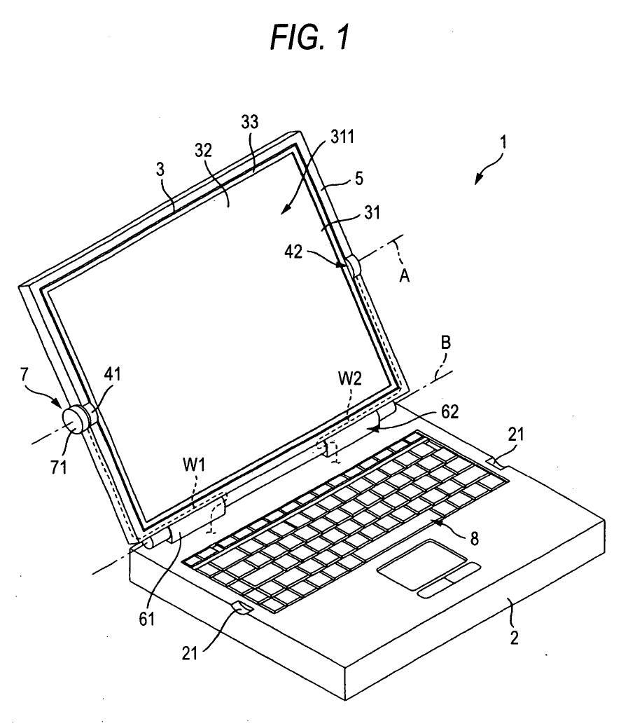

An electronic apparatus according to a first embodiment of the invention will be described with reference to FIGS. 1 to 6. The electronic apparatus 1 shown in FIG. 1 includes a body 2, a display device 3, inversion hinges, a support unit 5, rotation hinges, and an operation device 7. Hereinafter, for the sake of convenience of explanation, the right, left, top and bottom of the electronic apparatus will be defined in view from a user. A side near the user and a side far from the user will be defined as the front and rear of the electronic apparatus, respectively.

The body 2 has a keyboard 8 which is provided in an upper surface of the body 2 so as to be exposed. The display device 3 has a display unit 31, a touch panel 32, and a retention cover 33. For example, a liquid crystal display, a plasma display, an organic electroluminescence display or a surface-conduction electron-emitter display may be used as the display unit 31. The touch panel 32 is attached onto a display surface 311 of the display unit 31. The user can execute an input operation by touching displayed information.

The inversion hinges are provided as a first inversion hinge 41 and a second inversion hinge 42 which are paired with each other so as to be opposite to each other with respect to the display device 3. The first inversion hinge 41 is disposed on the left side of the display device 3. The second inversion hinge 42 is disposed on the right side of the display device 3.

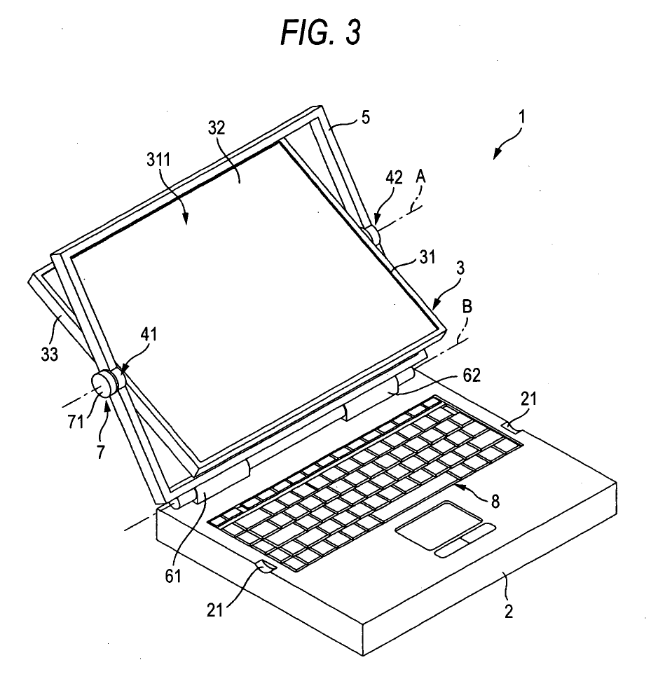

The display device 3 is connected to the support unit 5 by the first and second inversion hinges 41 and 42. As shown in FIG. 3, the first and second inversion hinges 41 and 42 operate to rotate the display device 3 on an inversion axis A which is set horizontally along the display surface 311. The inversion axis A is disposed so horizontally as to pass through the center of the display device 3 and to divide the display surface 311 into two equal parts vertically.

The rotation hinges are provided as a first rotation hinge 61 and a second rotation hinge 62 which are paired with each other so as to be arranged in a widthwise direction of the display device 3. The first rotation hinge 61 is disposed on the left of the rear side of the body 2 while the second rotation hinge 62 is disposed on the right of the rear side of the body 2.

The support unit 5 is connected to the body 2 by the first and second rotation hinges 61 and 62. The first and second rotation hinges 61 and 62 operate to rotate the support unit 5 relative to the body 2 on a rotation axis B which is set horizontally along the rear portion of the body 2. The support unit 5 is shaped like a frame which surrounds the outer circumference of the display device 3 and which has an outer circumference substantially equal to that of the body 2. In this embodiment, the inversion axis A and the rotation axis B are disposed in parallel to each other.

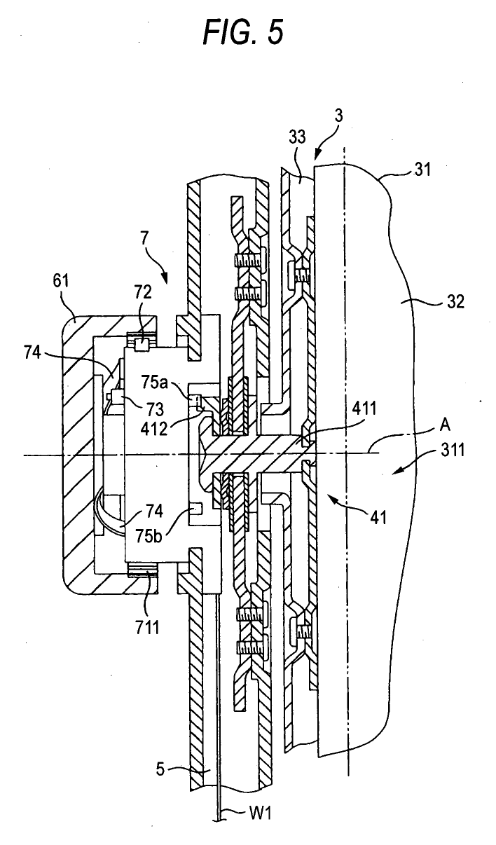

As shown in FIG. 1, the operation device 7, like the first inversion hinge 41, is provided on the left side of the support unit 5 so as to protrude from the support unit 5. As shown in FIG. 5, the operation device 7 has a knob portion 71, a dial detection switch 72, a push button switch 73, a spring washer 74, and inversion detection switches 75a and 75b.

The knob portion 71 is shaped like a mushroom. The center axis of the knob portion 71 is disposed so as to be coaxial with the inversion axis A. The knob portion 71 moves along the inversion axis A while rotating on the inversion axis A. The knob portion 71 has an internally toothed gear 711 formed in the inner circumferential surface of the knob portion 71. The internally toothed gear 711 engages with the dial detection switch 72. When the knob portion 71 rotates, the dial detection switch 72 detects peaks and troughs of the internally toothed gear 711 and outputs a pulse signal.

The push button switch 73 is disposed in such a manner that the push button switch 73 comes into contact with an inner surface of the knob portion 71 when the knob portion 71 is pushed toward the display device 3 side along the inversion axis A. Upon detection of contact with the knob portion 71, the push button switch 73 outputs a signal. The spring washer 74 pushes the knob portion 71 back along the inversion axis A in order to prevent the knob portion 71 from being kept in contact with the push button switch 73.

The inversion detection switches 75a and 75b are disposed so as to face on the first inversion hinge 41. The first inversion hinge 41 has an inversion shaft 411 which can rotate together with the display device 3. A striker 412 is fixed to an end of the inversion shaft 411 extending toward the support unit 5 side. The striker 412 strikes against the inversion detection switch 75a in a position where the display device 3 is in a first state. The striker 412 strikes against the inversion detection switch 75b in a position where the display device 3 is in a third state.

A signal cable W1 of the dial detection switch 72, the push button switch 73 and the inversion detection switches 75a and 75b passes through the first rotation hinge so as to be led into the inside of the body 2. Incidentally, each of the dial detection switch 72, the push button switch 73, and the inversion detection switches 75a and 75b is not limited to a contact switch. For example, an optical sensor, a magnetic sensor, a piezoelectric element or a strain gauge may be used as the switch.

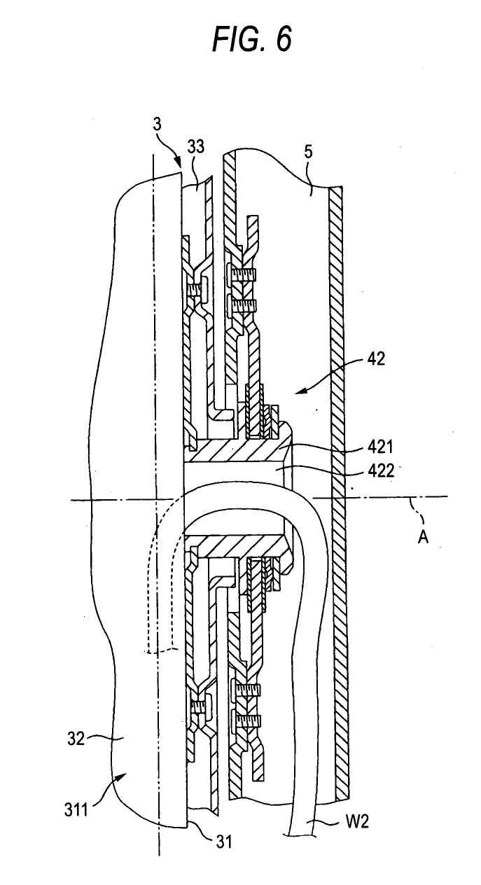

The second inversion hinge 42 has the same structure as that of the first inversion hinge 41. As shown in FIG. 6, an inversion shaft 421 however has a cable feed hole 422 which is provided along the inversion axis A so as to be coaxial with the inversion axis A. A signal cable W2 of the display device 3 is led out to the support unit 5 through the cable feed hole 422. Accordingly, even when the display device 3 is rotated by 180° relative to the support unit 5, there is no heavy load imposed on the signal cable W2. The signal cable W2 of the display device 3 passes through the second inversion hinge 42 and the second rotation hinge 62 so as to be led into the inside of the body 2.

Incidentally, either of the first and second inversion hinges 41 and 42 may be a cantilever inversion hinge with sufficient frictional resistance to retain the display device on the inversion axis A as long as sufficient stiffness and stability to support the display device 3 can be obtained.

As shown in FIGS. 1 to 4, portions of the support unit 5 where the first and second inversion hinges 41 and 42 are contained have outer shapes larger than the thickness of the display device 3, so that the portions of the support unit 5 swell out on opposite sides. The body 2 has recesses 21 which are provided along the swellings of the support unit 5 when the support unit 5 is laid on the body 2.

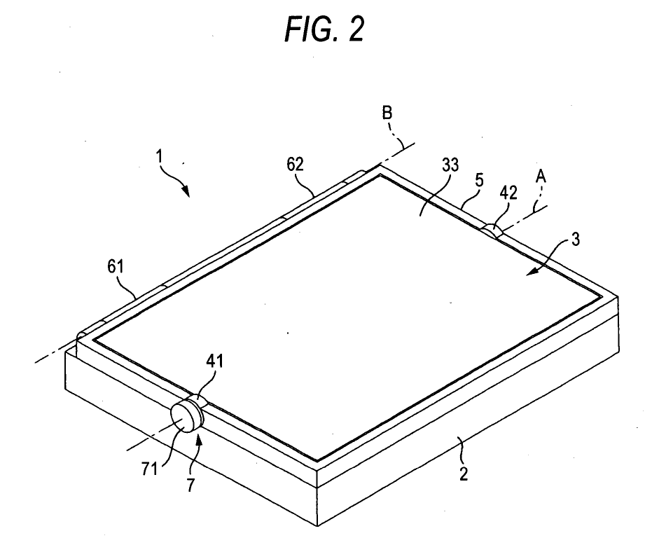

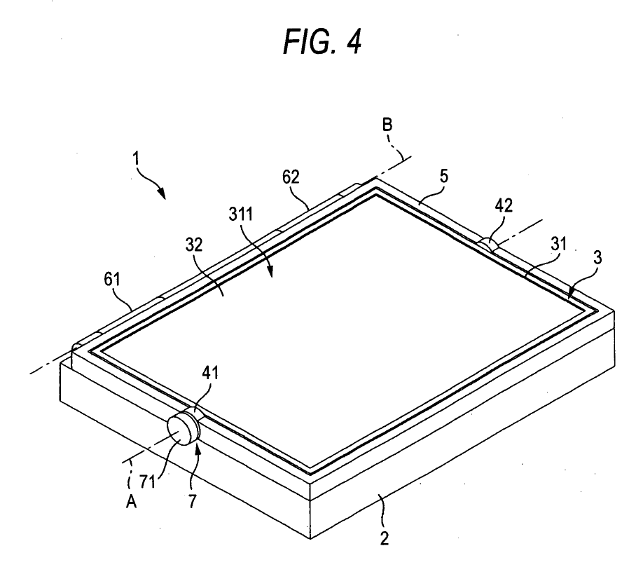

In the electronic apparatus 1 configured as described above, the inversion hinges and the rotation hinges are provided so that the display device 3 can be moved to any one of the three states, i.e., the first state shown in FIG. 2, the second state shown in FIG. 1 and the third state shown in FIG. 4. In the first state, the display device 3 is laid on the body 2 while the display surface 311 is turned toward the keyboard 8. Accordingly, in the first state, the electronic apparatus is in a so-called closed state in which the electronic apparatus is not in use. In the second state, the display device 3 rises up with respect to the body 2. Accordingly, in the second state, the electronic apparatus 1 is in a so-called key-in state in which the electronic apparatus 1 can be operated mainly by the keyboard 8. In the third state, the display device 3 is inverted and laid on the body while the display surface 311 is turned up in a direction opposite to the keyboard 8. Accordingly, in the third state, the electronic apparatus 1 is in a so-called tablet input state in which the electronic apparatus 1 can be operated mainly by the touch panel 32 attached onto the display device 3.

In addition, in the second state and the third state, the electronic apparatus 1 is formed so that information displayed on the display device 3 on the basis of an installed application program can be operated in accordance with a signal output from the operation device 7. A signal output from the dial detection switch 72 in accordance with rotation of the knob portion 71 and a signal output from the push button switch 73 in accordance with pushing of the knob portion 71 along the inversion axis A are used in combination to make a more complicated operation possible.

Particularly, a signal output from the dial detection switch 72 in accordance with rotation of the knob portion 71 is related to an operation based on the user's action of twisting the knob portion 71. With this configuration, the user can operate the operation device 7 sensuously, so that handling property is improved. Specifically, signal outputs may be allocated to an operation of scrolling displayed figures and character strings in accordance with the direction of rotation of the knob portion 71, an operation of changing a displayed application program in a launcher, an operation of changing brightness of the screen or volume of a speaker, and an operation of scaling up/down a selected image.

In addition, a signal output from the push button switch 73 in accordance with pushing of the knob portion 71 may be allocated to an operation of deciding the operation selected and adjusted on the basis of rotation of the knob portion 71 or an operation of canceling the previously decided operation when the knob portion 71 is pushed twice continuously in a short time.

Since the operation device 7 protrudes outward from the support unit 5, the operation device 7 can be operated not only in the case where the display device 3 is in the second state but also in the case where the display device 3 is in the third state. Particularly, in the third state in which the keyboard 8 is concealed under the display device 3, it is possible to use the operation device 7 fortunately.

Because the operation device 7 protrudes outward from the support unit 5, the user can take the knob portion 71 with the user's thumb and forefinger from opposite sides with respect to the inversion axis A. That is, handling property concerned with operation of the operation device 7 is unchanged regardless of the angle of rotation of the support unit 5 relative to the body 2, so that stable handling property can be obtained.

In the electronic apparatus 1 according to this embodiment, the operation device 7 is disposed on the left side of the display device 3 in the second state. Alternatively, the operation device 7 may be disposed on the right side. In this case, the first inversion hinge 41 is provided on the right side while the second inversion hinge 42 is provided on the left side. The signal cable W2 of the display device 3 is led out through an inversion hinge having a cable feed hole 422, similarly to the second inversion hinge 42 provided on a side opposite to the operation device 7 with respect to the display device 3.

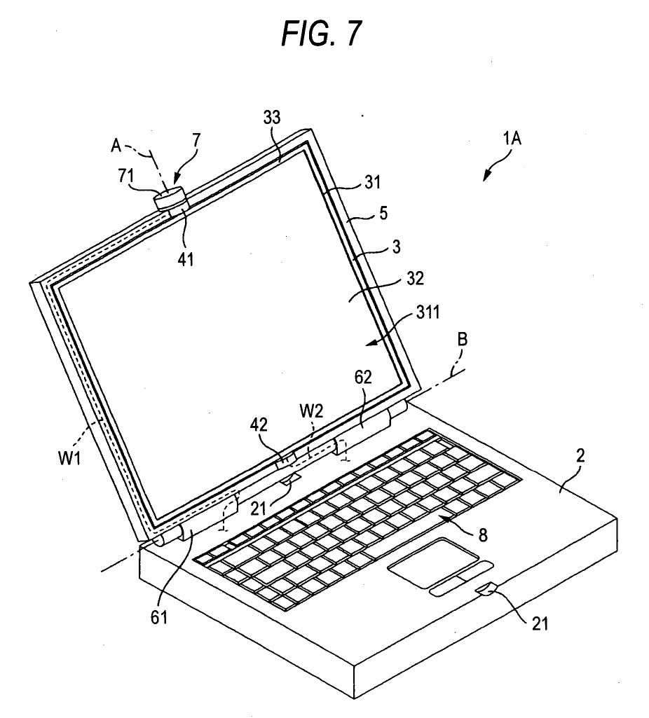

Next, an electronic apparatus 1A according to a second embodiment of the invention will be described with reference to FIGS. 7 to 10. Incidentally, constituent members having the same functions as those in the first embodiment are referred to by the same numerals, and description thereof will be omitted. In addition, since the sectional structures of the first and second inversion hinges 41 and 42 and the operation device 7 in the second embodiment are the same as those described in the first embodiment, FIGS. 5 and 6 and the description relevant to FIGS. 5 and 6 can be referred to and description about these inversion hinges and the operation device will be omitted here.

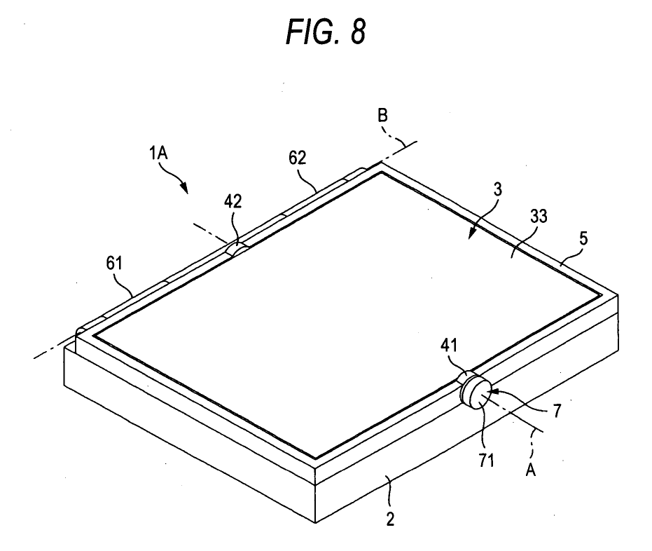

In the electronic apparatus 1A, the inversion axis A is disposed so as to be perpendicular to the rotation axis B. Accordingly, in the first state as shown in FIG. 8, the first inversion hinge 41 is provided on the front side while the second inversion hinge 42 is provided on the rear side. Recesses 21 are provided in an upper portion of the body 2 in accordance with the positions where the first and second inversion hinges 41 are provided.

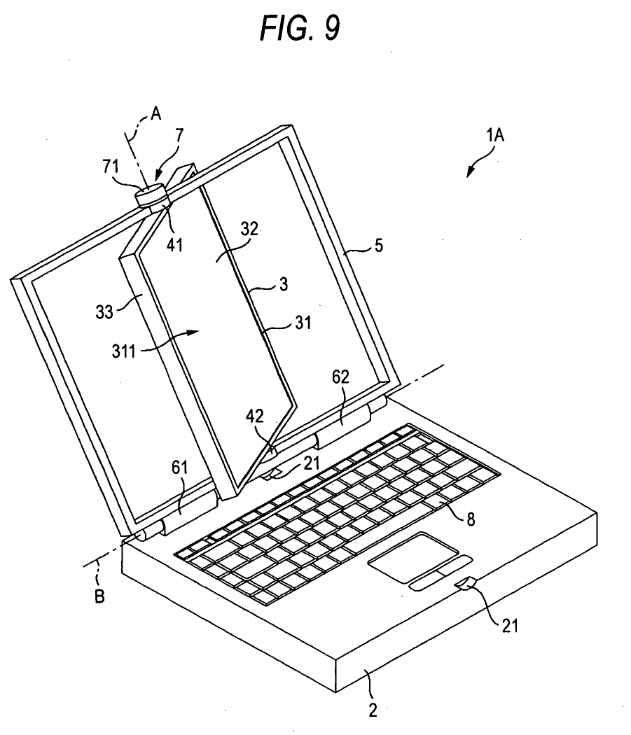

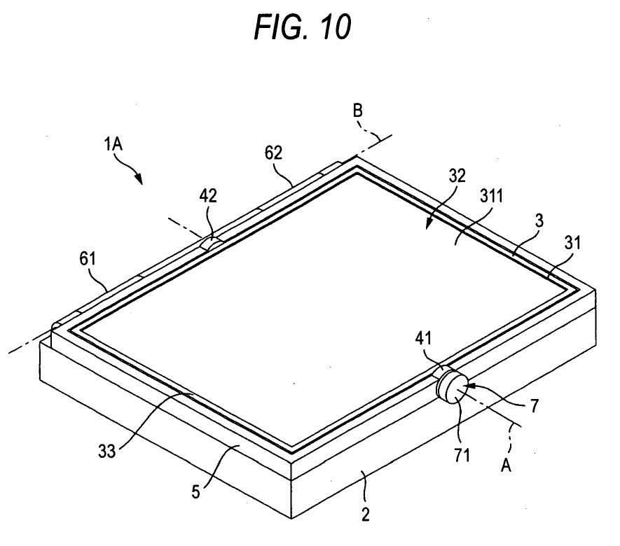

In the electronic apparatus 1A, the display device 3 can be moved to three states, that is, a first state shown in FIG. 8, a second state shown in FIG. 7 and a third state shown in FIG. 10. In order to move the display device 3 to the first/third state, the display device 3 in the second state is rotated on the inversion axis A by the first and second inversion hinges 41 and 42 as shown in FIG. 9.

In the electronic apparatus 1A configured as described above, particularly the operation device 7 is disposed in the center of the width of the display device 3. Accordingly, the operation device 7 can be operated easily by either right hand or left hand.

Although the first and second embodiments have been described on the case where the dial detection switch 72 and the push button switch 73 are contained in the operation device 7, the operation device 7 may further have a tensile detection switch provided for detecting an operation of pulling the knob portion 71 away from the display device 3 along the inversion axis A. In this case, the tensile detection switch may be provided so that the knob portion 71 can be pulled out in one stage or in two stages, like the winding knob of a watch.

What is claimed is:

1. An electronic apparatus comprising:
a body including a keyboard exposed on an upper surface hereof;
a display device including a display surface and movable to a first state, a second state and a third state, the first state in which the display device is laid on the body while the display surface faces toward the keyboard, the second state in which the display device rises up with respect to the body and the third state in which the display device is inverted and laid on the body while the display surface faces up in a direction opposite to the keyboard;
an inversion hinge for rotating the display device on an inversion axis to move the display device from the first state to the third state;
a support unit connected to the display device by the inversion hinge;
a rotation hinge rotating the support unit on a rotation axis provided along a rear side of the body while connecting the body and the support unit to each other; and
an operation device provided in the support unit coaxially with the inversion axis and for outputting a signal related to information displayed on the display device.

2. The electronic apparatus according to claim 1, wherein the inversion hinge includes a first inversion hinge, and a second inversion hinge paired with the first inversion hinge and disposed opposite to the first inversion hinge with respect to the display device,
wherein the rotation hinge includes a first rotation hinge, and a second rotation hinge paired with the first rotation hinge arranged in a widthwise direction of the display device,
wherein the operation device is disposed coaxially with the first inversion hinge,
wherein the operation device includes a signal cable led from the operation device into an inside of the body through the first rotation hinge, and
wherein the display device includes a signal cable led into the inside of the body through the second inversion hinge and the second rotation hinge.

3. The electronic apparatus according to claim 1, wherein the inversion axis passes through a center of the display device along the display surface.

4. The electronic apparatus according to claim 1, wherein the operation device outputs a signal when the operation device is pivoted on the inversion axis.

5. The electronic apparatus according to claim 1, wherein the operation device is operable to rotate around the inversion axis to output a signal.

6. The electronic apparatus according to claim 1, wherein the inversion axis is disposed parallel to the rotation axis.

7. The electronic apparatus according to claim 1, wherein the inversion axis is disposed perpendicular to the rotation axis.

8. The electronic apparatus according to claim 2, wherein:
the support unit includes a portion that accommodates at least one of the first inversion hinge and the second inversion hinge, the portion larger than the display device in thickness; and
the body has a recess that fits with an outer shape of the portion of the support unit, when the support unit is laid on the body.
